(19) United States
(12) Patent Application Publication
(10) Pub. No.: US 2024/0055749 A1
(43) Pub. Date: Feb. 15, 2024

(54) Rectangular Waveguide-to-Microstrip in-phase High-isolation Broadband Power Divider

(71) Applicant: SOUTHWEST ELECTRONICS TECHNOLOGY RESEARCH INSTITUTE (CHINA ELECTRONICS TECHNOLOGY GROUP CORPORATION, Chengdu, Sichuan (CN)

(72) Inventors: Zhang DANG, Chengdu, Sichuan (CN); Haifan ZHU, Chengdu, Sichuan (CN); Jian HUANG, Chengdu, Sichuan (CN); Zuolin LIU, Chengdu, Sichuan (CN); Bo LI, Chengdu, Sichuan (CN); Peng ZHAO, Chengdu, Sichuan (CN)

(21) Appl. No.: 17/923,918

(22) PCT Filed: Dec. 14, 2021
(86) PCT No.: PCT/CN2021/137937

§ 371 Date: Nov. 8, 2022

(30) Foreign Application Priority Data
Apr. 30, 2021 (CN) 202110483083.4

(51) Int. Cl. H01P 5/18

(52) U.S. Cl. CPC H01P 5/18

(57) ABSTRACT

Provided is a rectangular waveguide-to-microstrip in-phase high-isolation broadband power divider. A “[”-shaped slot on an end plane of a left waveguide body is divided into an upper waveguide body and a lower waveguide body by a center of a wide side, an input rectangular waveguide as a radio frequency signal input of the power divider is constituted by a “ [symbol] ”-shaped gap and the “[”-shaped opening slot together, two in-phase power division output ends with an equal phase of the power divider are constituted by two microstrip power division lines face to face, an electric field force line of a TE₁₀ electromagnetic field mode transmitted in the input rectangular waveguide is perpendicular to the surface of a thin-film resistor, and passes through two symmetrical power division microstrip probes, the three-section impedance power division microstrip probes are connected for impedance matching by the microstrip power division lines, the radio frequency signal in the input rectangular waveguide is equally divided into two routes, and enters the in-phase power division outputs ends respectively by the power division of the microstrip power division lines, to achieve the effect of power division.

### CROSS-REFERENCE TO RELATED APPLICATION

The present disclosure is based upon and claims priority to Chinese patent application CN202110483083.4, filed on Apr. 30, 2021 and entitled “Rectangular Waveguide-to-microstrip in-phase High-Isolation Broadband Power Divider”, the disclosure of which is hereby incorporated by reference in its entirety.

### TECHNICAL FIELD

The present disclosure relates to the field of microwave devices, in particular to a high-isolation broadband rectangular waveguide-to-microstrip power divider technology that may be widely used in the fields of communication, radar, electronic countermeasures, telemetry and remote sensing, industrial production and the like.

### BACKGROUND

Power divider is one of the most widely used devices in microwave systems, and is an important component in the various microwave systems. The power divider is a device that divides one route of input signal energy into two or more routes of output equal or unequal energy, and may also combine a plurality of routes of signal energy into one route of output in turn, so it may also be called as a combiner at this time. The main technical parameters include power losses (including insertion loss, distribution loss and return loss), VSWR on each port, isolation between distribution branch ports, power capacity and frequency bandwidth and the like. Herein the isolation between the distribution branch ports is an important indicator of the power divider to ensure that an input power from each distribution branch port may only be transmitted to the main port and not to other branchers.

In recent years, the newer and stricter requirements are proposed for a new-type power divider by people: a smaller size, a higher power handling capability, and more convenient integration with chips. As a microwave device that may be directly integrated with the chips, a waveguide-to-microstrip power divider plays an indispensable role in the fields of communication systems, radar arrays, and telemetry and remote sensing and the like. Especially in a system that requires a high power, a single chip is often insufficient, so power divider is designed for power combining. In order to prevent mutual cross-interference between signals during combination, the power divider needs to have a good isolation. The waveguide-to-microstrip power divider is used for the power combining, and it is directly related to the maximum power to which the entire system may achieve. The isolation, phase imbalance, insertion loss and other indicators of the waveguide-to-microstrip power divider are directly related to the combining performance of a high-power system. Although microwave circuit is developed towards a trend of easy integration, the waveguide-to-microstrip power divider with high power, low loss and high-frequency performance still plays an irreplaceable role.

Generally, the power divider with an operating frequency higher than 300 MHz is defined as a microwave power divider. A main function of it is to split a microwave signal into 2 or more routes of coherent signals with different magnitudes, and at the same time, a plurality of routes of microwave signals with the different powers may be also combined into one route of output in turn. During the whole process, the frequency of the microwave signal is not changed, only the magnitude and phase are changed. For example, the power divider based on the waveguide transmission is widely applied in a high power situation, such as H-plane T-junction, E-plane T-junction, and magic T.

There are various circuit forms of the power divider, such as Wilkinson, Lange, hybrid coupler, T-type junction, a Y-type junction, and magic T commonly. According to the needs of the application, a variety of microwave transmission lines including a microstrip line, a stripline, a coaxial line, a coplanar waveguide (CPW), a substrate integrated waveguide (SIW), a rectangular waveguide and the like may be used independently or mixed to achieve. According to a reciprocity theorem, the three-port power divider such as the T-type structure may be known that the isolation is not good. This may lead to signal crosstalk between the output ports, so it is generally used in a front end of a power division network. The bandwidth of the Y-type junction is not very good relative to the T-type junction, and usually it needs to add some matching originals. In order to obtain a magic T with good performance, in an existing technology, in addition to adding a matching element at the magic T connector, a metal diaphragm or a metal cylinder is also added to an E-arm, this increases certain difficulty to the manufacture of the magic T.

The various waveguide structures may be divided into two categories, namely a planar structure and a non-planar structure. The planar structure includes the microstrip line, CPW, a slot line and the like. The traditional planar transmission line power divider (such as Wilkinson, hybrid coupler, and ring coupler) has a low quality factor and is easy to achieve a wide bandwidth, but it has the disadvantages of large loss and small power capacity and the like. The non-planar structure includes rectangular waveguide, coaxial line, dielectric waveguide and the like. The planar structure is suitable for the hybrid integration of a system. However, this structure also has its own defects. Due to the existence of conductor loss, radiation loss, and dielectric loss, the planar structure is not beneficial to work in a millimeter-wave frequency, and may not form a component of a high-Q value. As a stereo structure, the non-planar structure is very difficult to effectively integrate with the planar structure or an active device. For a hybrid-type power divider of the rectangular waveguide and the microstrip, a main mode of the rectangular waveguide is the TE₁₀ mode; and a main mode of the microstrip is the quasi-TEM mode. Herein, the rectangular waveguide has the high power capacity as a main transmission line, and the microstrip lines are branch ends for easy integration of the semiconductor devices. A common method for this type of the power dividerr is to insert a plurality of symmetrically distributed microstrip probes inside the waveguide, to achieve the signal transition and complete the power division at the same time. Because it is one-time transition and division, it has the advantages of compact circuit form, small insertion loss and the like. However, due to the lack of an isolation circuit in the power divider that simply inserts the microstrip probes into the rectangular waveguide, the isolation between the microstrip branch ports is theoretically only 6 dB, it is difficult to apply to systems, such as the feed network of the array antenna, balanced frequency mixer, and high-power combination, having the higher requirements (usually it requires 15 dB) on the isolation between channels.

According to different positions and directions in which the microstrip probes are inserted into the waveguide, the existing microstrip power distributors for the rectangular waveguide may be divided into three phase difference types of 0° (in-phase), 90° (orthogonal), and 180° (out-of-phase). Herein, the rectangular waveguide-to-microstrip in-phase power divider uses the microstrip probes symmetrically inserted at the center of the wide side at the same side of the rectangular waveguide. Since the probes are parallel to the electric field line of the TE₁₀ mode transmitted in it, the high-efficiency signal transition between the waveguide and the microstrip line is achieved. At the same time, since two microstrip probes are inserted into the wide side at the same side of the rectangular waveguide and are symmetrical, the radio frequency signal in the rectangular waveguide is equally divided into two routes of the same phase (in-phase) and enters the microstrip line respectively. In the circuit performance of the power divider, in addition to the power division characteristics, it is often necessary to have the good isolation between the distributed ports, namely it is required that the radio frequency signals of the two microstrip probes may not enter the microstrip line of the other party mutually; otherwise, the purpose of isolation may not be achieved because input signals of the two microstrip probes may be coupled with each other.

Existing known related technologies for improving the isolation of the waveguide-to-microstrip power divider, for example, a patent application with the application number of 202110047178.1 discloses a method for increasing isolation, based on the effect of a T-shaped coupling circuit constituted by a microstrip power division probe and a microstrip isolation probe on a direction of an electric field line of a probe end face, the isolation between the two microstrip power division ports is achieved. However, an isolation mode of this patent application needs to be achieved by adding an isolation end, it is only valid for the out-of-phase power divider, not suitable for the port isolation of the waveguide-to-microstrip in-phase power divider, and the bandwidth achieved by the isolation is limited.

### SUMMARY

In view of the above technical problems, an embodiment of the present disclosure provide a rectangular waveguide-to-microstrip in-phase broadband power divider with high isolation and good magnitude and phase balance. A thin-film resistor is introduced in a position, perpendicular to the end faces of the microstrip probes, in a rectangular waveguide, and the vertical component of the electric field that causes mutual coupling of two microstrip probes is absorbed, thereby the isolation between two microstrip power division ports is achieved.

A technical scheme adopted in the embodiment of the present disclosure is as follows: a rectangular waveguide-to-microstrip in-phase high-isolation broadband power divider, including: a left waveguide body 1, an upper waveguide body 2, and a lower waveguide body 3 which are fixedly connected by a bolt to constitute the complete power divider and divided by a center of a narrow side and a wide side of an input rectangular waveguide 4, herein the upper waveguide body 2 is mirror-symmetrical to the lower waveguide body 3 back to back, herein the “[”-shaped slot on the end plane of the left waveguide body 1 divides the upper waveguide body 2 and the lower waveguide body 3 by using the wide side as a center, the rectangular slot is formed by a “ [symbol] ”-shaped gap and the “[”-shaped opening slot together which are opposite-symmetrical up and down, to constitute the input rectangular waveguide 4 as a radio frequency signal input of the power divider, and the center of the wide side on the same side is used as a symmetry plane, two in-phase power division output ends 6 with an equal phase of the power divider are constituted by two face to face microstrip power division lines 10 of the upper waveguide body 2 and the lower waveguide body 3, and a ceramic substrate 7 of a support thin-film resistor 8 for enhancing the isolation characteristics of the power divider is inlaid in a position, towards a power division microstrip probe 9, of a terminal end of the rectangular slot, an electric field force line of a TE₁₀ electromagnetic field mode transmitted in the input rectangular waveguide 4 is perpendicular to the surface of the thin-film resistor 8, and passes through two symmetrical power division microstrip probes 9, the three-section impedance power division microstrip probes 9 are connected for impedance matching by the microstrip power division lines 10, the radio frequency signal in the input rectangular waveguide 4 is equally divided into two routes, and enters the in-phase power division outputs ends 6 respectively by the power division of the microstrip power division lines 10, to achieve the effect of power division.

The embodiment of the present disclosure has the following beneficial effects compared with an existing technology.

The isolation is high. In the embodiment of the present disclosure, the upper waveguide body 2 and the lower waveguide body 3 are divided according to the “[”-shaped slot on the end plane of the left waveguide body 1 by using the wide side as the center, herein the upper waveguide body 2 and the lower waveguide body 3 are mirror-symmetrical back to back, and the in-phase power division output end 6, by the middle opening slot of the upper and lower terminals, passes through the coaxial inner conductor 5 to the microstrip power division line 10. By adding the thin-film resistor 8 perpendicular to the end face of the power division microstrip probe 9 in the input rectangular waveguide 4 of propagating the TE₁₀ mode and supporting it with the ceramic substrate 7, since the thin-film resistor is perpendicular to the electric field force line of the TE₁₀ electromagnetic field mode, the radio frequency signal of the TE₁₀ mode in the rectangular waveguide under a normal condition may not be absorbed by the thin-film resistor, namely it may not affect the loss of the power divider and the normal power division characteristics. While the input radio frequency signal enters the rectangular waveguide from one microstrip probe, the electric field at the end face of the probe may be coupled and deflected under the influence of the other microstrip probe symmetrical to it, to form an electric field component perpendicular to the two microstrip probes. Since the coupled electric field component is parallel to the thin-film resistor, it is absorbed and may not enter the other microstrip probe opposite to it face to face, thereby the isolation between the two microstrip power division output ends is achieved. Due to the strong heat dissipation capability of the ceramic substrate, it has a feature of large power capacity. This type of transition from the waveguide to the microstrip is used to achieve the power division, so that the power divider has a smaller insertion loss while a better return loss is maintained.

According to the embodiment of the present disclosure, the “[”-shaped slot on the end plane of the left waveguide body 1 divides the upper waveguide body 2 and the lower waveguide body 3 by using the wide side as the center, the rectangular slot is formed by the “ [symbol] ”-shaped gap and the “[”-shaped opening slot together which are opposite-symmetrical up and down, to constitute the input rectangular waveguide 4 as the radio frequency signal input of the power divider, and the center of the wide side on the same side is used as the symmetry plane, two in-phase power division output ends 6 with the equal phase of the power divider are constituted by two face to face microstrip power division lines 10 of the upper waveguide body 2 and the lower waveguide body 3, and the ceramic substrate 7 of the support thin-film resistor 8 for enhancing the isolation characteristics of the power divider is inlaid in the position, towards the power division microstrip probe 9, of the terminal end of the rectangular slot. The three-section impedance power division microstrip probes 9 are connected for impedance matching by the microstrip power division lines 10; and the electric field force line of the TE₁₀ electromagnetic field mode transmitted in the input rectangular waveguide 4 is perpendicular to the surface of the thin-film resistor 8 and is not affected, the radio frequency signal in the input rectangular waveguide 4 is equally divided into two routes by two symmetrical power division microstrip probes 9, and enters the in-phase power division outputs ends 6 respectively by the power division of the microstrip power division lines 10, to achieve the effect of power division. Signals from the two in-phase power division output ends 6 are coupled and deflected by the electric field on the end faces of the two symmetrical power division microstrip probes 9, and the formed electric field component is parallel to the surface of the thin-film resistor 8 and is absorbed by it, to achieve the isolation between in-phase power division output ends of the signal power division between the two microstrip lines, and finally it is achieved that an equal-power and same-phase distribution signal is isolated and output from the two in-phase power division output ends 6.

According to the embodiment of the present disclosure, the signals from the two in-phase power division output ends 6 are coupled and deflected by the electric field on the end faces of the two symmetrical power division microstrip probes 9, and the formed electric field component is parallel to the surface of the thin-film resistor 8 and is absorbed by it, to achieve the isolation between in-phase power division output ends of the signal power division between the two microstrip lines. The radio frequency signal in the input rectangular waveguide 4 is equally divided into two routes by two symmetrical power division microstrip probes 9, and enters the in-phase power division outputs ends 6 respectively by the power division of the microstrip power division lines 10, to achieve the effect of power division, and finally the equal-power distribution signal is isolated and output from the ports of the in-phase power division output ends 6 respectively. The isolation of the rectangular waveguide-to-microstrip in-phase power divider achieves a good effect under the action of the thin-film resistor 8, at the same time the overall performance index of the power divider is improved, and the impedance matching of each port in the wide frequency band is achieved; and compared with a waveguide-type directional coupler, it has better isolation, smaller size, and improved bandwidth and performance, and the isolation circuit is simple and compact in form, the structure processing and assembly are convenient.

### BRIEF DESCRIPTION OF THE DRAWINGS

FIG. 1 is a structure schematic diagram of a rectangular waveguide-to-microstrip in-phase high-isolation broadband power divider according to an embodiment of the present disclosure.

FIG. 2 is a structure schematic diagram of a left waveguide body in FIG. 1.

FIG. 3 is a top view three-dimensional schematic diagram of an upper waveguide body in FIG. 1.

FIG. 4 is a top view three-dimensional schematic diagram of a lower waveguide body in FIG. 1.

FIG. 5 is a circuit principle schematic diagram of FIG. 1.

FIG. 6 is an electric field force line diagram of a TE₁₀ mode of FIG. 1.

FIG. 7 is the scattering parameter magnitudes of FIG. 1.

In the drawings: 1. Left waveguide body, 2. Upper waveguide body, 3. Lower waveguide body, 4. Input rectangular waveguide, 5. Coaxial inner conductor, 6. in-phase power division output end, 7. Ceramic substrate, 8. Thin-film resistor, 9. Power division microstrip probe, 10. Microstrip power division line, and 11. Waveguide flange mounting screw hole.

The content of the present disclosure is further elaborated below in combination with the drawings.

### DETAILED DESCRIPTION OF THE EMBODIMENTS

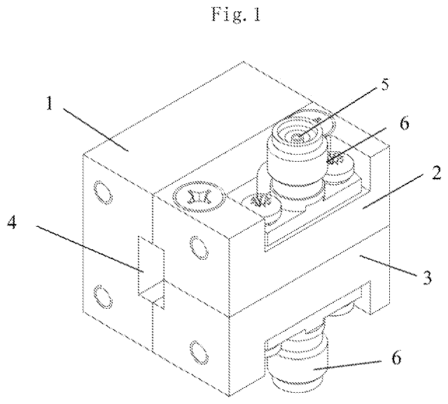

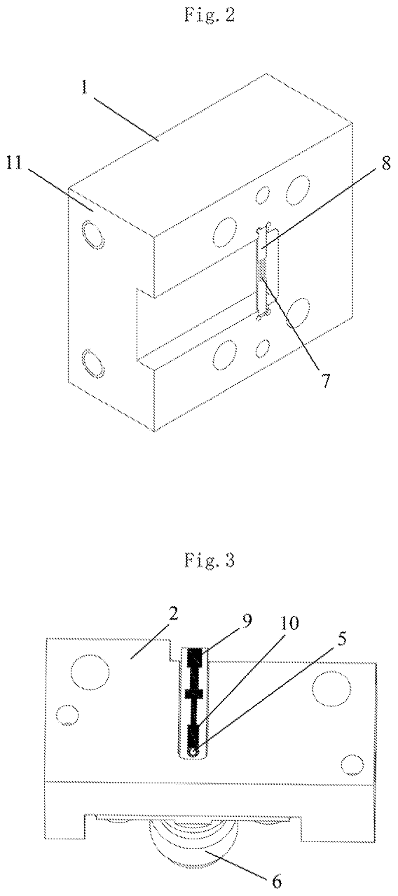

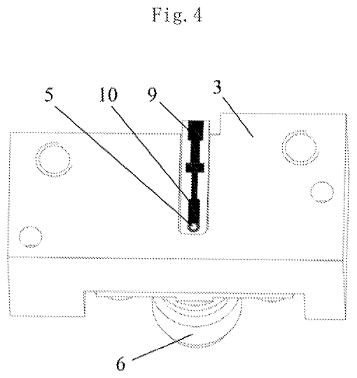

Referring to FIG. 1-FIG. 6, in a preferred embodiment described below, a rectangular waveguide-to-microstrip in-phase high-isolation broadband power divider, including: a left waveguide body 1, an upper waveguide body 2, and a lower waveguide body 3 which are fixedly connected by a bolt to constitute the complete power divider and divided by a center of a narrow side and a wide side of an input rectangular waveguide 4, herein the upper waveguide body 2 is mirror-symmetrical to the lower waveguide body 3 back to back, herein a “[”-shaped slot on an end plane of the left waveguide body 1 divides the upper waveguide body 2 and the lower waveguide body 3 by using the wide side as a center, a rectangular slot is formed by a “ [symbol] ”-shaped gap and the “[”-shaped opening slot together which are opposite-symmetrical up and down, to constitute an input rectangular waveguide 4 as a radio frequency signal input of the power divider, and the center of the wide side on the same side is used as a symmetry plane, two in-phase power division output ends 6 with an equal phase of the power divider are constituted by two face to face microstrip power division lines 10 of the upper waveguide body 2 and the lower waveguide body 3, and a ceramic substrate 7 of a support thin-film resistor 8 for enhancing the isolation characteristics of the power divider is inlaid in a position, towards a power division microstrip probe 9, of a terminal end of the rectangular slot, an electric field force line of a TE₁₀ electromagnetic field mode transmitted in the input rectangular waveguide 4 is perpendicular to the surface of the thin-film resistor 8 and is not affected, and passes through two symmetrical power division microstrip probes 9, the three-section impedance power division microstrip probes 9 are connected for impedance matching by the microstrip power division lines 10, the radio frequency signal in the input rectangular waveguide 4 is equally divided into two routes, and enters the in-phase power division outputs ends 6 respectively by the power division of the microstrip power division lines 10, to achieve the effect of power division.

Signals of the two in-phase power division output ends 6 are coupled and deflected by an electric field on end faces of the two symmetrical power division microstrip probes 9, a formed electric field component is parallel to the surface of the thin-film resistor 8 and is absorbed by it, to achieve the isolation between the in-phase power division output ends of the signal power division between the two microstrip lines, and finally it is achieved that an equal-power and same-phase distribution signal is isolated and output from the two in-phase power division output ends 6.

The phase difference power division output end 6, by the middle opening slot of upper and lower terminal ends, passes through a coaxial inner conductor 5 to the microstrip power division line 10.

The ceramic substrate 7 is made of an aluminum nitride ceramic, and the fixing of the ceramic substrate 7 is achieved by slotting on a narrow side wall of the left waveguide body 1.

The thin-film resistor 8 and the power division microstrip probes 9 are perpendicular to each other and are in non-contact, only a vertical component of the electric field between the two power division microstrip probes 9 is absorbed.

The power division microstrip probe 9 completes the impedance matching with 50Ω of the microstrip power division line 10 after three-section impedance line transformation and is connected with it. After the interconnection between the microstrip power division line 10 and a test coaxial connector is completed, the termination characteristic impedance is also a power division output test of the in-phase power division output end 6 of 50Ω of the coaxial connector (50Ω characteristic impedance here is an industry test system standard, and therefore it needs to be matched to 50Ω). A middle opening hole is designed in the terminal end of 50Ω of the microstrip power division line 10, and coaxial inner conductor 5 of the two in-phase power division output ends 6 respectively passes through the opening hole from the back of the upper waveguide body 2 and the lower waveguide body 3 and is welded to the microstrip power division line 10. A side face of the left waveguide body 1 is provided with a waveguide flange mounting screw hole 11.

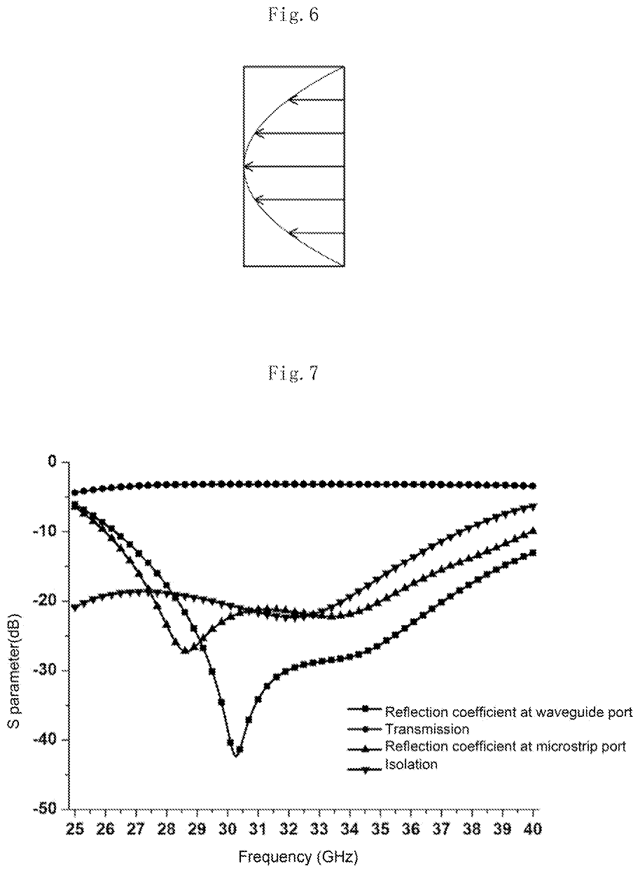

The electric field force line of the TE₁₀ electromagnetic field mode transmitted in the input rectangular waveguide 4 is shown in an arrow line in FIG. 6 (the electric field force line is parallel to the narrow side of the rectangular waveguide); because the power division microstrip probe 9 is parallel to the electric field force line of the TE₁₀ electromagnetic field mode, the high-efficiency signal conversion between the waveguide and the microstrip line is achieved; the two power division microstrip probes 9 placed face to face are symmetrically arranged around the center of the wide side of the input rectangular waveguide 4, the radio frequency signal is sent from the end face of the input rectangular waveguide 4, and the thin-film resistor 8 supported by the vertical ceramic substrate 7 is added in the middle position of the end face of the power division microstrip probe 9, to constitute a non-contact coupling structure with the end face of the power division microstrip probe 9. While the input radio frequency signal enters the waveguide from the two power division microstrip probes 9 at the same time, two routes of the end face electric fields may be bent the influence of each other to form two electric field components parallel to the thin-film resistor 8, and they cancel mutually because the sizes are equal but the direction are opposite, and the remaining electric field components perpendicular to it may be superimposed in the same direction to excite the TE₁₀ mode, and this is an inverse process of the power divider—power combiner.

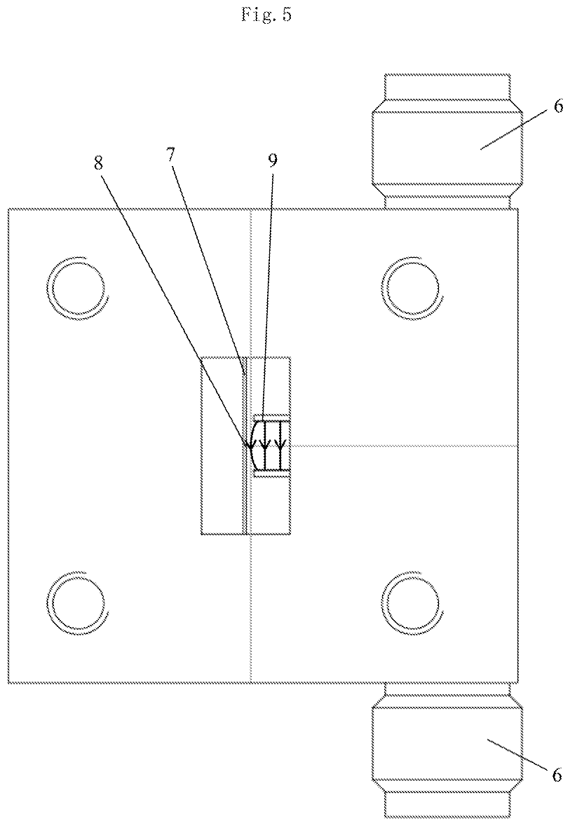

Because the thin-film resistance 8 is orthogonal to the electric field force line of the TE₁₀ electromagnetic field mode, the radio frequency signal of the TE₁₀ mode transmitted in the waveguide input end 4 under the normal condition may not be absorbed by the thin-film resistance 8, namely it may not cause any effects on the normal power division characteristics and loss of the power divider; after the input radio frequency signal enters the rectangular waveguide 1 from the power division microstrip probe 9, the electric field at the end face thereof may be coupled and deflected under the influence of the other power division microstrip probe 9 symmetrical to it, to form an electric field component perpendicular to the two microstrip probes shown in an arrow line in FIG. 5. Since the coupled electric field component is parallel to the thin-film resistor 8, it is absorbed and may not enter the power division microstrip probe 9, thereby the isolation between the two in-phase power division output ends 6 is achieved; while the input radio frequency signal enters the rectangular waveguide 1 from the power division microstrip probe 9, it has the same effect; while the input radio frequency signal enters the waveguide from the power division microstrip probes 9 at the same time, two routes of the end face electric fields may be bent under the influence of each other, to form two electric field components parallel to the thin-film resistor 8 that the sizes are the same but the directions are opposite; and therefore, they cancel and may not be absorbed by the thin-film resistor 8, and the remaining electric field components perpendicular to it may be superimposed in the same direction to excite the TE₁₀ mode, and this is actually the inverse process of the power divider—power combiner.

The effect of the high-isolation rectangular waveguide-to-microstrip in-phase power divider is as shown in FIG. 7, the reflection coefficient of the waveguide input end 4 is better than −15 dB, and the in-phase power division output end 6 outputs −3 dB of equal-magnitude and in-phase power distribution by the power division, and the reflection coefficient is better than −18 dB. The relative bandwidth for the isolation higher than 15 dB is as high as 25%. Apparently, by adopting the power divider structure of the present disclosure, the isolation between the output ends may meet the requirements of circuits such as a feed network of the array antenna, balanced frequency mixer, and high-power combination.

Those of ordinary skill in the art may realize that the embodiments described here are to help a reader understand the principles of the present disclosure, and it should be understood that a scope of protection of the present disclosure is not limited to such special statements and embodiments. For those skilled in the art, the present disclosure may have various modifications and changes. Any modifications, equivalent replacements, improvements and the like made within the spirit and principle of the present disclosure shall be included within a scope of the claims of the present disclosure.

What is claimed is:

1. A rectangular waveguide-to-microstrip in-phase high-isolation broadband power divider, comprising: a left waveguide body (1), an upper waveguide body (2), and a lower waveguide body (3) which are fixedly connected by a bolt to constitute the complete power divider and divided by a center of a narrow side and a wide side of an input rectangular waveguide (4), wherein the upper waveguide body (2) is mirror-symmetrical to the lower waveguide body (3) back to back, wherein the left waveguide body (1) is independent of the upper waveguide body (2) and the lower waveguide body (3) mutually, and the upper waveguide body (2) and the lower waveguide body (3) are divided by a wide side of a “[” shaped slot in a right half portion of a rectangular slot, the rectangular slot is formed by a “ [symbol] ” shaped gap and the “[” shaped opening slot together which are opposite-symmetrical up and down, to constitute the input rectangular waveguide (4) as a radio frequency signal input of the power divider, and a center of the wide side on the same side is used as a symmetry plane, two in-phase power division output ends (6) with an equal phase of the power divider are constituted by two face to face microstrip power division lines (10) of the upper waveguide body (2) and the lower waveguide body (3), and a ceramic substrate (7) of a support thin-film resistor (8) for enhancing the isolation characteristics of the power divider is inlaid in a position, towards a power division microstrip probe (9), of a terminal end of the rectangular slot, an electric field force line of a TE₁₀ electromagnetic field mode transmitted in the input rectangular waveguide (4) is perpendicular to the surface of the thin-film resistor (8), and passes through two symmetrical power division microstrip probes (9), the three-section impedance power division microstrip probes (9) are connected for impedance matching by the microstrip power division lines (10), the radio frequency signal in the input rectangular waveguide (4) is equally divided into two routes, and enters the in-phase power division outputs ends (6) respectively by the power division of the microstrip power division lines (10), to achieve the effect of power division.

2. The rectangular waveguide-to-microstrip in-phase high-isolation broadband power divider according to claim 1, wherein signals of the two in-phase power division output ends (6) are coupled and deflected by an electric field on end faces of the two symmetrical power division microstrip probes (9), a formed electric field component is parallel to the surface of the thin-film resistor (8) and is absorbed by it, to achieve the isolation between the in-phase power division output ends of the signal power division between the two microstrip lines, and finally it is achieved that an equal-power and same-phase distribution signal is isolated and output from the two in-phase power division output ends (6).

3. The rectangular waveguide-to-microstrip in-phase high-isolation broadband power divider according to claim 1, wherein the phase difference power division output end (6), by the middle opening slot of upper and lower terminal ends, passes through a coaxial inner conductor (5) to the microstrip power division line (10).

4. The rectangular waveguide-to-microstrip in-phase high-isolation broadband power divider according to claim 1, wherein the ceramic substrate (7) is made of an aluminum nitride ceramic, and the fixing of the ceramic substrate (7) is achieved by slotting on a narrow side wall of the left waveguide body (1).

5. The rectangular waveguide-to-microstrip in-phase high-isolation broadband power divider according to claim 1, wherein the thin-film resistor (8) and the power division microstrip probes (9) are perpendicular to each other and are in non-contact, only a vertical component of the electric field between the two power division microstrip probes (9) is absorbed.

6. The rectangular waveguide-to-microstrip in-phase high-isolation broadband power divider according to claim 1, wherein the power division microstrip probe (9) completes the impedance matching with 50Ω of the microstrip power division line (10) after three-section impedance line transformation and is connected with it.

7. The rectangular waveguide-to-microstrip in-phase high-isolation broadband power divider according to claim 6, wherein after the interconnection between the microstrip power division line (10) and a test coaxial connector is completed, the termination characteristic impedance is also a power division output test of the in-phase power division output end (6) of 50Ω of the coaxial connector.

8. The rectangular waveguide-to-microstrip in-phase high-isolation broadband power divider according to claim 7, wherein a middle opening hole is designed in the terminal end of 50Ω of the microstrip power division line (10), and coaxial inner conductor (5) of the two in-phase power division output ends (6) respectively passes through the opening hole from the back of the upper waveguide body (2) and the lower waveguide body (3) and is welded to the microstrip power division line (10).

9. The rectangular waveguide-to-microstrip in-phase high-isolation broadband power divider according to claim 1, wherein the radio frequency signal enters from the input rectangular waveguide (4), wherein the transmitted electric field force line of the TE₁₀ electromagnetic field mode is parallel to the power division microstrip probes (9), to achieve the high-efficiency signal conversion between the waveguide and the microstrip line; and while the input radio frequency signal enters the waveguide from the two power division microstrip probes (9) at the same time, two routes of the end face electric fields can produce the bending under the mutual effect to form two electric field components parallel to the thin-film resistor (8), they cancel each other due to the same magnitude but opposite directions, and the remaining electric field components perpendicular to it can be superimposed in the same direction to excite the TE₁₀ mode, this is an inverse process of the power divider—power combiner.

10. The rectangular waveguide-to-microstrip in-phase high-isolation broadband power divider according to claim 1, wherein the two power division microstrip probes (9) placed face to face are symmetrically arranged by using the wide side of the input rectangular waveguide (4) as a center, the radio frequency signal is sent from the end face of the input rectangular waveguide (4), and the thin-film resistor (8) supported by the vertical ceramic substrate (7) is added in a middle position of the end face of the power division microstrip probe (9), to constitute a non-contact coupling structure with the end face of the power division microstrip probe (9).
